(19) United States
(12) Patent Application Publication
(10) Pub. No.: US 2026/0045179 A1
(43) Pub. Date: Feb. 12, 2026

(54) METHODS AND SYSTEMS FOR ANATOMICAL MODELING AND MAPPING

(71) Applicant: St. Jude Medical, Cardiology Division, Inc., St. Paul, MN (US)

(72) Inventors: Jatin Surendra Relan, Bordeaux (FR); Steven J. Kim, New York, NY (US)

(21) Appl. No.: 19/291,095

(22) Filed: Aug. 5, 2025

Related U.S. Application Data
(60) Provisional application No. 63/679,745, filed on Aug. 6, 2024.

(51) Int. Cl. G09B 23/30

(52) U.S. Cl. CPC G09B 23/30

(57) ABSTRACT

In an electrophysiology study, an electroanatomical mapping system receives user input specifying a geometric model to be generated and an electrophysiology map to be generated. The system then receives a plurality of data points from a multi-electrode catheter, with each data point including at least location data and optionally electrophysiology data. The system then assigns each data point to the geometric model and the electrophysiology map. A “model only” mode, where each data point is assigned only to the geometric model, and a “map only” mode, where each data point is assigned only to the electrophysiology map are also contemplated.

### CROSS-REFERENCE TO RELATED APPLICATIONS

The present application claims the benefit of U.S. provisional application No. 63/679,745, filed 6 Aug. 2024, which is hereby incorporated by reference as though fully set forth herein.

### BACKGROUND

The present disclosure relates generally to anatomical modeling and mapping, such as may be performed in cardiac diagnostic and therapeutic procedures. In particular, the present disclosure relates to methods and systems for generating cardiac geometry and/or electrophysiology maps from data collected by a roving electrophysiology probe, such as a high density (“HD”) grid catheter or other multi-electrode device.

Cardiac mapping, including the generation of cardiac geometries and electrocardiographic mapping, is a part of numerous cardiac diagnostic and therapeutic procedures. As the complexity of such procedures increases, however, the geometries and electrophysiology maps utilized must increase in quality, in density, and in the rapidity and ease with which they can be generated.

It is known to use a multi-electrode catheter, such as an HD grid catheter, to gather data points used in the creation of cardiac geometries and/or electrophysiology maps. In extant systems, map data (that is, data reflecting cardiac electrical activity) is often coupled to model data (that is, data reflecting the geometric structure of the heart or a portion thereof) using group-specific projection techniques, closest surface projection techniques, or other projection techniques.

Where surfaces of the model are very close to each other, however, these projection techniques can result in incorrect or inaccurate projections. For instance, near the mitral valve, map points from the left atrium can inadvertently be projected the left ventricle, and vice versa. Similarly, near the septum, points from the left side of the heart can inadvertently be projected to the right side of the heart, and vice versa.

### BRIEF SUMMARY

The instant disclosure provides a method of conducting an electrophysiology study that includes the following steps: receiving, at an electroanatomical mapping system, a first user input specifying a geometric model to be generated; receiving, at the electroanatomical mapping system, a second user input specifying an electrophysiology map to be generated; after receiving the first user input and the second user input, receiving, at the electroanatomical mapping system, a plurality of data points from a multi-electrode catheter, wherein each data point of the plurality of data points includes location data; and the electroanatomical mapping system assigning each data point of the plurality of data points to the geometric model and the electrophysiology map.

The method can also include the electroanatomical mapping system: generating a surface bounding the geometric model from the plurality of data points assigned to the geometric model; outputting a graphical representation of the surface; and outputting a graphical representation of the electrophysiology map on the graphical representation of the surface according to the location data of the plurality of data points assigned to the electrophysiology map. In embodiments of the disclosure, a respective data point is only output as part of the graphical representation of the electrophysiology map when the location data of the respective data point places the respective data point within a preset projection distance threshold of the surface.

It is also contemplated that the method can include: receiving, at the electroanatomical mapping system, a third user input splitting the geometric model into a first geometric model and a second geometric model; the electroanatomical mapping system reassigning a first subset of the plurality of data points from the geometric model to the first geometric model; and the electroanatomical mapping system reassigning a second subset of the plurality of data points from the geometric model to the second geometric model.

For example, the third user input can include a bounding box drawn on a graphical representation of a surface bounding the geometric model, wherein the bounding box defines the first geometric model and the second geometric model is defined by removing the first geometric model from the geometric model. The electroanatomical mapping system can include a respective data point within the first subset of the plurality of data points when the location data of the respective data point places the respective data point within the bounding box, and otherwise include the respective data point within the second subset of the plurality of data points.

Also disclosed herein is a method of conducting an electrophysiology study, including: receiving, at an electroanatomical mapping system, a first user input specifying one of a modeling mode, a mapping mode, or a combined modeling and mapping mode; when the user input specifies the modeling mode, receiving, at the electroanatomical mapping system, a second user input specifying a geometric model to be generated; when the user input specifies the mapping mode, receiving, at the electroanatomical mapping system, a third user input specifying an electrophysiology map to be generated; when the user input specifies the combined modeling and mapping mode, receiving, at the electroanatomical mapping system, a fourth user input specifying both the geometric model to be generated and the electrophysiology map to be generated; after receiving the first user input and either the second user input, the third user input, or the fourth user input, receiving, at the electroanatomical mapping system, a plurality of data points from a multi-electrode catheter, wherein each data point of the plurality of data points includes location data; when the user input specifies the modeling mode, the electroanatomical mapping system assigning each data point of the plurality of data points only to the geometric model; when the user input specifies the mapping mode, the electroanatomical mapping system assigning each data point of the plurality of data points only to the electrophysiology map; and when the user input specifies the combined modeling and mapping mode, the electroanatomical mapping system assigning each data point of the plurality of data points to both the geometric model and the electrophysiology map.

The method can further include, when the user input specifies the modeling mode, the electroanatomical mapping system: generating a surface bounding the geometric model from the plurality of data points assigned only to the geometric model; and outputting a graphical representation of the surface. The electroanatomical mapping system can output the graphical representation of the electrophysiology map on the graphical representation of the surface according to one of: a group-specific projection of the plurality of data points to the graphical representation of the surface; and a closest surface projection of the plurality of data points to the graphical representation of the surface.

The method can further include, when the user input specifies the mapping mode, the electroanatomical mapping system assigning each data point of the plurality of data points to the geometric model according to one of: a group-specific projection of the plurality of data points to the geometric model; and a closest surface projection of the plurality of data points to the geometric model.

The method can further include, when the user input specifies the combined modeling and mapping mode, the electroanatomical mapping system: generating a surface bounding the geometric model from the plurality of data points assigned to the geometric model; outputting a graphical representation of the surface; and outputting a graphical representation of the electrophysiology map on the graphical representation of the surface according to the location data of the plurality of data points assigned to the electrophysiology map. A respective data point may be output as part of the graphical representation of the electrophysiology map only when the location data of the respective data point places the respective data point within a preset projection distance threshold of the surface.

In embodiments of the disclosure, the method further includes: receiving, at the electroanatomical mapping system, a fifth user input splitting the geometric model into a first geometric model and a second geometric model; the electroanatomical mapping system reassigning a first subset of the plurality of data points from the geometric model to the first geometric model; and the electroanatomical mapping system reassigning a second subset of the plurality of data points from the geometric model to the second geometric model.

The fifth user input can include a bounding box drawn on the graphical representation of the surface, wherein the bounding box defines the first geometric model and the second geometric model is defined by removing the first geometric model from the geometric model. The electroanatomical mapping system can include a respective data point within the first subset of the plurality of data points when the location data of the respective data point places the respective data point within the bounding box, and otherwise include the respective data point within the second subset of the plurality of data points.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic diagram of an exemplary electroanatomical mapping system.

FIG. 2 depicts an exemplary HD grid catheter that can be used in connection with aspects of the instant disclosure.

FIG. 3 is a flowchart of representative steps that can be carried out according to aspects of the instant disclosure.

FIG. 4 represents a model-splitting process according to aspects of the instant disclosure.

FIG. 5 illustrates the use of a bounding box as part of the model-splitting process depicted in FIG. 4.

While multiple embodiments are disclosed, still other embodiments of the present disclosure will become apparent to those skilled in the art from the following detailed description, which shows and describes illustrative embodiments. Accordingly, the drawings and detailed description are to be regarded as illustrative in nature and not restrictive.

### DETAILED DESCRIPTION

The instant disclosure provides methods and systems for generating anatomical models (geometric models) and maps (electrophysiology maps). Aspects of the disclosure will be described below with reference to data points collected using a high density (HD) grid catheter, such as the Advisor™ HD grid mapping catheter from Abbott Laboratories (Abbott Park, Illinois), in conjunction with an electroanatomical mapping system, such as the EnSite Precision™ cardiac mapping system, also from Abbott Laboratories. Those of ordinary skill in the art will understand, however, how to apply the teachings herein to good advantage in other contexts and/or with respect to other devices.

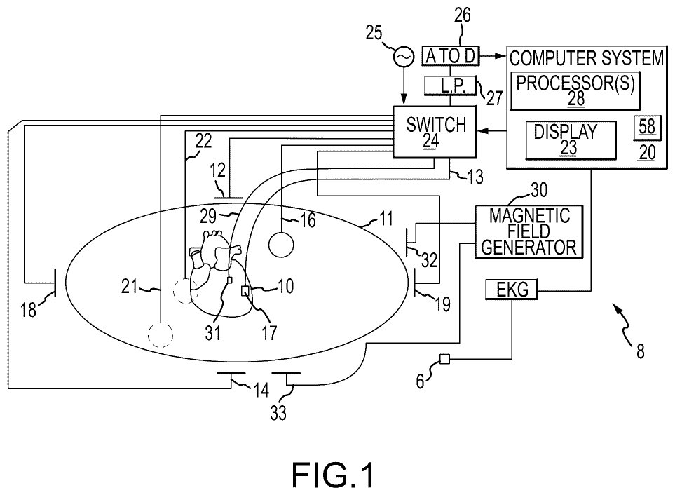

FIG. 1 shows a schematic diagram of an exemplary electroanatomical mapping system 8 for conducting cardiac electrophysiology studies by navigating a cardiac catheter and measuring electrical activity occurring in a heart 10 of a patient 11 and three-dimensionally mapping the electrical activity and/or information related to or representative of the electrical activity so measured. System 8 can be used, for example, to create an anatomical model (sometimes also referred to as a “geometric model”) of the patient's heart 10 using one or more electrodes. System 8 can also be used to measure electrophysiology data at a plurality of points along a cardiac surface and store the measured data in association with location information for each measurement point at which the electrophysiology data was measured, for example to create an map of the electrical activity in the patient's heart 10 (referred to as an “electrophysiology map”).

As one of ordinary skill in the art will recognize, system 8 determines the location, and in some aspects the orientation, of objects, typically within a three-dimensional space, and expresses those locations as position information determined relative to at least one reference. This is referred to herein as “localization.”

For simplicity of illustration, the patient 11 is depicted schematically as an oval. In the embodiment shown in FIG. 1, three sets of surface electrodes (e.g., patch electrodes) 12, 14, 16, 18, 19, and 22 are shown applied to a surface of the patient 11, pairwise (e.g., 12/14, 18/19, and 16/22) defining three generally orthogonal axes, referred to herein as an x-axis, a y-axis, and a z-axis. In other embodiments the electrodes could be positioned in other arrangements, for example multiple electrodes on a particular body surface. As a further alternative, the electrodes do not need to be on the body surface but could instead be positioned internally to the body.

In FIG. 1, the x-axis surface electrodes (e.g., 12/14) are applied to the patient along a first axis, such as on the lateral sides of the thorax region of the patient (e.g., applied to the patient's skin underneath each arm) and may be referred to as the Left and Right electrodes. The y-axis electrodes (e.g., 16/22) are applied to the patient along a second axis generally orthogonal to the x-axis, along the sternum and spine of the patient in the thorax region, and may be referred to as the Chest and Back electrodes. The z-axis electrodes (e.g., 18/19) are applied along a third axis generally orthogonal to both the x-axis and the y-axis, such as along the inner thigh and neck regions of the patient, and may be referred to as the Left Leg and Neck electrodes. The heart 10 lies between these pairs of surface electrodes 12/14, 16/22, and 18/19.

Each surface electrode can measure multiple signals. For example, in embodiments of the disclosure, each surface electrode can measure three resistance (impedance) signals and three reactance signals. These signals can, in turn, be grouped into three resistance/reactance signal pairs. One resistance/reactance signal pair can reflect driven values, while the other two resistance/reactance signal pairs can reflect non-driven values (e.g., measurements of the electric field generated by other driven pairs in a manner similar to that described below for electrodes 17).

An additional surface reference electrode (e.g., a “belly patch”) 21 provides a reference and/or ground electrode for the system 8. The belly patch electrode 21 may be an alternative to a fixed intra-cardiac electrode 31, described in further detail below. In alternative embodiments where system 8 is capable of magnetic field-based localization instead of or in addition to impedance-based localization, the surface electrode 21 can alternatively or additionally include a magnetic patient reference sensor-anterior (“PRS-A”) positioned on the patient's chest.

It should be appreciated that patient 11 may also have most or all of the conventional electrocardiogram (“ECG” or “EKG”) system leads in place. In certain embodiments, for example, a standard set of 12 ECG leads may be utilized for sensing electrocardiograms on the patient's heart 10. This ECG information is available to system 8 (e.g., it can be provided as input to computer system 20) and may be used, for example, as a gating signal for the acquisition of data via catheter 13 (e.g., to ensure that data collected are from a common cardiac phase and/or to group data collected from a common cardiac phase together in common geometric models and/or electrophysiology maps). Insofar as ECG leads are well understood, and for the sake of clarity in the figures, only a single lead 6 and its connection to computer 20 is illustrated in FIG. 1.

A representative catheter 13 having at least one electrode 17 is also shown. This representative catheter electrode 17 is referred to as the “roving electrode,” “moving electrode,” or “measurement electrode” throughout the specification. Typically, multiple electrodes 17 on catheter 13, or on multiple such catheters, will be used. In one embodiment, for example, the system 8 may comprise sixty-four electrodes on twelve catheters disposed within the heart and/or vasculature of the patient. In other embodiments, system 8 may utilize a single catheter that includes multiple (e.g., eight) splines, each of which in turn includes multiple (e.g., eight) electrodes.

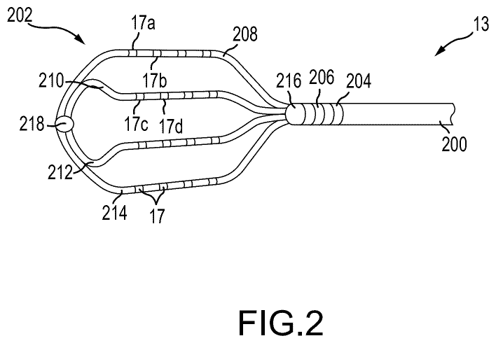

The foregoing embodiments are merely exemplary, however, and any number of electrodes and/or catheters may be used. For example, for purposes of this disclosure, a segment of an exemplary multi-electrode catheter, and in particular an HD grid catheter 13 such as the Abbott Laboratories Advisor™ HD Grid Mapping Catheter, Sensor Enabled™ (Abbott Park, Illinois), is shown in FIG. 2.

HD grid catheter 13 includes a catheter body 200 coupled to a paddle 202. Catheter body 200 can further include first and second body electrodes 204, 206, respectively. Paddle 202 can include a first spline 208, a second spline 210, a third spline 212, and a fourth spline 214, which are coupled to catheter body 200 by a proximal coupler 216 and to each other by a distal coupler 218. In one embodiment, first spline 208 and fourth spline 214 can be one continuous segment and second spline 210 and third spline 212 can be another continuous segment. In other embodiments, the various splines 208, 210, 212, 214 can be separate segments coupled to each other (e.g., by proximal and distal couplers 216, 218, respectively). It should be understood that HD catheter 13 can include any number of splines; the four-spline arrangement shown in FIG. 2 is merely exemplary.

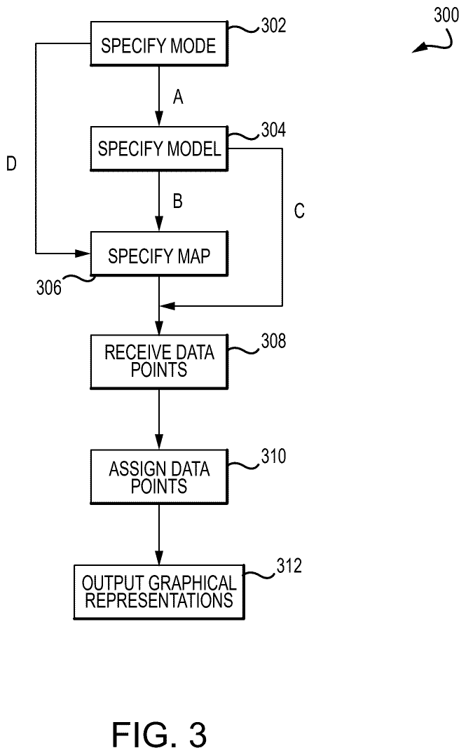

As described above, splines 208, 210, 212, 214 can include any number of electrodes 17; in FIG. 2, sixteen electrodes 17 are shown arranged in a four-by-four array. It should also be understood that electrodes 17 can be evenly and/or unevenly spaced, as measured both along and between splines 208, 210, 212, 214. For purposes of easy reference in this description, FIG. 3A provides alphanumeric labels for electrodes 17.

As the ordinarily-skilled artisan will appreciate, electrodes 17 can be used to measure both unipolar and bipolar electrograms. There are also known techniques that allow bipolar electrograms to be combined to generate electrograms in any orientation of the plane of catheter 13 without physically changing the orientation of catheter 13 (often known as “omnipolar electrograms”).

As will be apparent from the foregoing description, catheter 13 can be used to simultaneously collect a plurality of electrophysiology data points for the various unipoles and bipoles defined by electrodes 17 thereon. Each such electrophysiology data point includes both localization information (e.g., position of a unipole; position and orientation of a selected bipole) and corresponding electrogram signals (e.g., unipolar, bipolar, and/or omnipolar electrograms).

Catheter 13 (or multiple such catheters) are typically introduced into the heart and/or vasculature of the patient via one or more introducers and using familiar procedures. Indeed, various approaches to introduce catheter 13 into a patient's heart, such as transseptal approaches, will be familiar to those of ordinary skill in the art, and therefore need not be further described herein.

Since each electrode 17 lies within the patient, location data may be collected simultaneously for each electrode 17 by system 8. Similarly, each electrode 17 can be used to gather electrophysiological data from the cardiac surface (e.g., endocardial electrograms). The ordinarily skilled artisan will be familiar with various modalities for the acquisition and processing of electrophysiology data points (including, for example, both contact and non-contact electrophysiological mapping), such that further discussion thereof is not necessary to the understanding of the techniques disclosed herein. Likewise, various techniques familiar in the art can be used to generate graphical representations of cardiac geometry (“modeling”) and/or cardiac electrical activity (“mapping”) from the plurality of electrophysiology data points. Moreover, insofar as the ordinarily skilled artisan will appreciate how to create electrophysiology maps from electrophysiology data points, the aspects thereof will only be described herein to the extent necessary to understand the present disclosure.

Returning now to FIG. 1, in some embodiments, an optional fixed reference electrode 31 (e.g., attached to a wall of the heart 10) is shown on a second catheter 29. For calibration purposes, this electrode 31 may be stationary (e.g., attached to or near the wall of the heart) or disposed in a fixed spatial relationship with the roving electrodes (e.g., electrodes 17), and thus may be referred to as a “navigational reference” or “local reference.” The fixed reference electrode 31 may be used in addition or alternatively to the surface reference electrode 21 described above. In many instances, a coronary sinus electrode or other fixed electrode in the heart 10 can be used as a reference for measuring voltages and displacements; that is, as described below, fixed reference electrode 31 may define the origin of a coordinate system.

Each surface electrode is coupled to a multiplex switch 24, and the pairs of surface electrodes are selected by software running on a computer 20, which couples the surface electrodes to a signal generator 25. Alternately, switch 24 may be eliminated and multiple (e.g., three) instances of signal generator 25 may be provided, one for each measurement axis (that is, each surface electrode pairing).

The computer 20 may comprise, for example, a conventional general-purpose computer, a special-purpose computer, a distributed computer, or any other type of computer. The computer 20 may comprise one or more processors 28, such as a single central processing unit (“CPU”), or a plurality of processing units, commonly referred to as a parallel processing environment, which may execute instructions to practice the various aspects described herein.

Generally, three nominally orthogonal electric fields are generated by a series of driven and sensed electric dipoles (e.g., surface electrode pairs 12/14, 16/22, and 18/19) in order to realize catheter navigation in a biological conductor. Alternatively, these orthogonal fields can be decomposed and any pairs of surface electrodes can be driven as dipoles to provide effective electrode triangulation. Likewise, the electrodes 12, 14, 18, 19, 16, and 22 (or any number of electrodes) could be positioned in any other effective arrangement for driving a current to or sensing a current from an electrode in the heart. For example, multiple electrodes could be placed on the back, sides, and/or belly of patient 11. Additionally, such non-orthogonal methodologies add to the flexibility of the system. For any desired axis, the potentials measured across the roving electrodes resulting from a predetermined set of drive (source-sink) configurations may be combined algebraically to yield the same effective potential as would be obtained by simply driving a uniform current along the orthogonal axes.

Thus, any two of the surface electrodes 12, 14, 16, 18, 19, 22 may be selected as a dipole source and drain with respect to a ground reference, such as belly patch 21, while the unexcited electrodes measure voltage with respect to the ground reference. The roving electrodes 17 placed in the heart 10 are exposed to the field from navigational currents and are measured with respect to ground, such as belly patch 21. In practice the catheters within the heart 10 may contain more or fewer electrodes than the sixteen shown, and each electrode potential may be measured. As previously noted, at least one electrode may be fixed to the interior surface of the heart to form a fixed reference electrode 31, which is also measured with respect to ground, such as belly patch 21, and which may be defined as the origin of the coordinate system relative to which system 8 measures positions. Data sets from each of the surface electrodes, the internal electrodes, and the virtual electrodes may all be used to determine the location of the roving electrodes 17 within heart 10.

The measured voltages may be used by system 8 to determine the location in three-dimensional space of the electrodes inside the heart, such as roving electrodes 17 relative to a reference location, such as reference electrode 31. That is, the voltages measured at reference electrode 31 may be used to define the origin of a coordinate system, while the voltages measured at roving electrodes 17 may be used to express the location of roving electrodes 17 relative to the origin. In some embodiments, the coordinate system is a three-dimensional (x, y, z) Cartesian coordinate system, although other coordinate systems, such as polar, spherical, and cylindrical coordinate systems, are contemplated.

As should be clear from the foregoing discussion, the data used to determine the location of the electrode(s) within the heart is measured while the surface electrode pairs impress an electric field on the heart. The electrode data may also be used to create a respiration compensation value used to improve the raw location data for the electrode locations as described, for example, in U.S. Pat. No. 7,263,397, which is hereby incorporated herein by reference in its entirety. The electrode data may also be used to compensate for changes in the impedance of the body of the patient as described, for example, in U.S. Pat. No. 7,885,707, which is also incorporated herein by reference in its entirety.

Therefore, in one representative embodiment, system 8 first selects a set of surface electrodes and then drives them with current pulses. While the current pulses are being delivered, electrical activity, such as the voltages measured with at least one of the remaining surface electrodes and in vivo electrodes, is measured and stored. Compensation for artifacts, such as respiration and/or impedance shifting, may be performed as indicated above.

In aspects of the disclosure, system 8 can be a hybrid system that incorporates both impedance-based (e.g., as described above) and magnetic-based localization capabilities. Thus, for example, system 8 can also include a magnetic source 30, which is coupled to one or more magnetic field generators. In the interest of clarity, only two magnetic field generators 32 and 33 are depicted in FIG. 1, but it should be understood that additional magnetic field generators (e.g., a total of six magnetic field generators, defining three generally orthogonal axes analogous to those defined by patch electrodes 12, 14, 16, 18, 19, and 22) can be used without departing from the scope of the present teachings. Likewise, those of ordinary skill in the art will appreciate that, for purposes of localizing catheter 13 within the magnetic fields so generated, can include one or more magnetic localization sensors (e.g., coils).

In some embodiments, system 8 is the EnSite™ X, EnSite™ Velocity™, or EnSite Precision™ electrophysiological mapping and visualization system of Abbott Laboratories. Other localization systems, however, may be used in connection with the present teachings, including for example the RHYTHMIA HDX™ mapping system of Boston Scientific Corporation (Marlborough, Massachusetts), the CARTO navigation and location system of Biosense Webster, Inc. (Irvine, California), the AURORA® system of Northern Digital Inc. (Waterloo, Ontario), Stercotaxis, Inc.'s NIOBE® Magnetic Navigation System (St. Louis, Missouri), as well as MediGuide™ Technology from Abbott Laboratories.

The localization and mapping systems described in the following patents (all of which are hereby incorporated by reference in their entireties) can also be used with the present invention: U.S. Pat. Nos. 6,990,370; 6,978,168; 6,947,785; 6,939,309; 6,728,562; 6,640,119; 5,983,126; and 5,697,377.

Aspects of the disclosure relate to the creation of geometric models and electrophysiology maps of heart 10 (or, in some instances, portions of heart 10, such as a specific chamber). System 8 can therefore include a modeling and mapping module 58. Modeling and mapping module 58 may be software based (e.g., a series of programming instructions executed on processor(s) 28 of computer 20), hardware-based (e.g., an application specific integrated circuit (ASIC)), or a combination thereof.

Exemplary methods according to aspects of the instant disclosure will be explained with reference to the flowchart 300 of representative steps presented as FIG. 3. In some embodiments, for example, flowchart 300 may represent several exemplary steps that can be carried out by electroanatomical mapping system 8 of FIG. 1 (e.g., by processor 28 and/or modeling and mapping module 58). It should be understood that the representative steps described below can be hardware-implemented, software-implemented, or implemented in a combination of hardware and software. For the sake of explanation, the term “signal processor” may be used to encompass both hardware- and software-based implementations of the teachings herein.

In block 302, system 8 receives user input specifying a modeling mode, a mapping mode, or a combined modeling and mapping mode. The various modes will be described in further detail below, beginning with the combined modeling and mapping mode.

In the combined modeling and mapping mode, flowchart 300 follows path A from block 302 to block 304. In block 304, system 8 receives user input specifying a geometric model to be generated. Those of ordinary skill in the art will be familiar with how to specify, through the user interface of an electroanatomical mapping system, a geometric model to be generated, such that a detailed explanation of block 304 is not required for an understanding of the instant disclosure. Briefly, however, block 304 can include identifying the chamber or other cardiac volume within which catheter 13 is positioned for data collection (e.g., left atrium, left ventricle, and so on) and setting various parameters for data collection and/or model generation (e.g., sampling rate, fill type, and the like).

In the combined modeling and mapping mode, flowchart 300 follows path B from block 304 to block 306. In block 306, system 8 receives user input specifying an electrophysiology map to be generated. As with block 304, those of ordinary skill in the art will be familiar with how to specify, through the user interface of an electroanatomical mapping system, an electrophysiology map to be generated, such that a detailed explanation of block 306 is not required for an understanding of the instant disclosure. Briefly, however, block 306 can include identifying the cardiac rhythm being mapped (e.g., sinus rhythm) and setting various parameters for data collection and/or map generation (e.g., sampling rate, detection algorithm, data point inclusion criteria, and the like).

In the combined modeling and mapping mode, flowchart 300 proceeds from block 306 to block 308. In block 308, system 8 receives a plurality of data points from multi-electrode catheter 13. Each of the plurality of data points includes at least localization data (e.g., information regarding the position and/or orientation of catheter 13 at the point of collection) and optionally also includes electrophysiology information (e.g., information regarding the electrical activity on the heart at, or sufficiently near, the point of collection). A data point that includes only localization data can be referred to as a “model points;” those that include both localization data and electrophysiology information can be referred to as “map points” (or, alternatively, “electrophysiology data points” or “EP data points”). Insofar as the ordinarily-skilled artisan will readily appreciate how map and model points are collected, a detailed explanation of block 308 is not necessary to an understanding of the instant disclosure.

Flowchart 300 next proceeds to block 310. In block 310, system 8 assigns each data point received in block 308 to a geometric model and/or an electrophysiology map. In the combined modeling and mapping mode, system 8 assigns each data point to both the geometric model specified in block 304 (e.g., a left atrium model) and the electrophysiology map specified in block 306 (e.g., a sinus rhythm map) in block 310.

Next, the modeling mode will be described. Beginning again at block 302, flowchart 300 follows path A to block 304. In the modeling mode, however, flowchart 300 follows path C out of block 304, skipping block 306 and proceeding directly to block 308, and from block 308 to block 310. In the modeling mode, system 8 assigns each data point only to the geometric model specified in block 304 (e.g., a left atrium model) in block 310. No electrophysiology map is initially assigned (e.g., in block 310) to any data point in the modeling mode.

Finally, the mapping mode will be described. Beginning again at block 302, flowchart 300 follows path D out of block 302, skipping block 304 and proceeding directly to block 306, and then on to blocks 308 and 310. In the mapping mode, system 8 assigns each data point only to the electrophysiology map specified in block 306 (e.g., a sinus rhythm map) in block 310. No geometric model is initially assigned (e.g., in block 310) to any data point in the mapping mode.

System 8 can generate and output various graphical representations of the data points in block 312. In the combined modeling and mapping mode, for example, system 8 can generate a surface bounding the geometric model from the data points that are assigned to the model in block 310 (according to techniques that will be familiar to those of ordinary skill in the art) and output a graphical representation of the surface (e.g., on display 23). System 8 can also generate the electrophysiology map (e.g., a map of local activation times, local conduction velocities, cycle lengths, and so on) from the data points that are assigned to the map in block 310 and output a graphical representation of the map on the graphical representation of the surface (once again, according to known techniques).

Because each data point is pre-assigned to both a model and a map (according to the user input in blocks 304 and 306) in the combined modeling and mapping mode, instances of electrophysiology data for certain data points being projected to incorrect or inaccurate model surfaces are advantageously minimized. Of course, it is also contemplated that electrophysiology data for a respective data point may only be output as part of the graphical representation (that is, projected to the surface) if the data point lies within a preset projection distance threshold of the surface. The projection distance threshold can be user-adjustable within a range of between about 0 mm to about 30 mm; in certain aspects of the disclosure, the default projection distance threshold can be about 7 mm.

In aspects of the disclosure, a user can redefine the geometric model originally specified in block 304 into two (or more, if desired) geometric models, with system 8 automatically reassigning data points into subsets corresponding to the newly-defined geometric models.

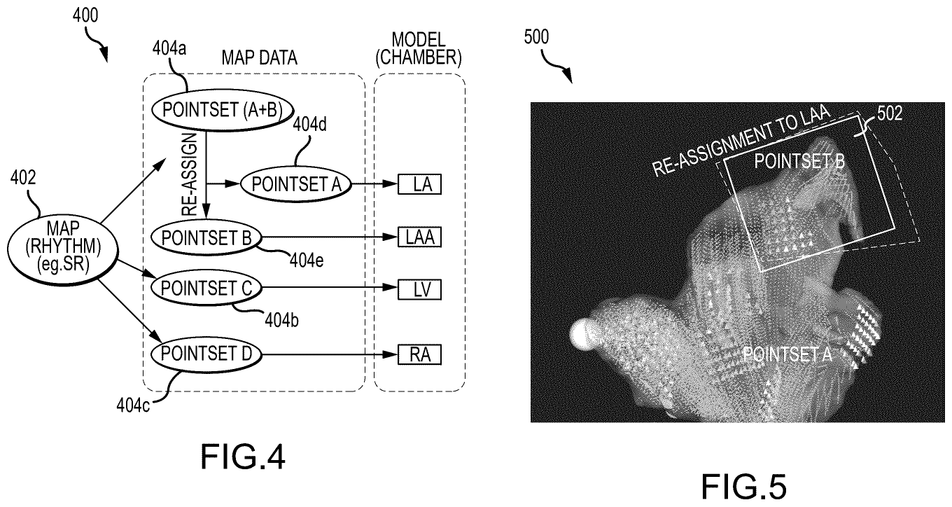

An exemplary splitting process 400 is represented in FIG. 4. Oval 402 represents a set of data points, all of which are assigned to a single electrophysiology map—as illustrated, a sinus rhythm map. Each data point is also assigned to one (and only one) model data set corresponding to one of three geometric models—a data set 404a that corresponds to a model that combines the left atrium and left atrial appendage, a data set 404b that corresponds to a model of the left ventricle, and a data set 404c that corresponds to a model of the right atrium.

Assume the practitioner desires to split the combined model of the left atrium and the left atrial appendage into discrete models of the left atrium and left atrial appendage. Because any given data point can only have one associated model (though it can have one or more associated maps), data set 404a must likewise be split into two data sets: data set 404d corresponding to a model of the left atrium and data set 404e corresponding to a model of the left atrial appendage.

Using a graphical representation 500 of the surface bounding the geometric models, such as shown in FIG. 5, the practitioner can draw a bounding box 502 around one of the regions into which the combined model is to be split. As shown in FIG. 5, bounding box 502 is drawn around the left atrial appendage, but this is merely exemplary and the description below would be analogous if bounding box 502 had instead been drawn around the left atrium.

In any event, system 8 reassigns data points from data set 404a that fall within bounding box 502 to data set 404e corresponding to the model of the left atrial appendage. All other data points from data set 404a are reassigned to data set 404d corresponding to the model of the left atrium. In effect, the data points falling within bounding box 502 are removed from the combined data set 404a and the corresponding model of the left atrial appendage is removed from the combined model of the left atrial appendage and left atrium.

Aspects of block 312 in the modeling mode and the mapping mode are similar to the foregoing description of block 312 in the combined modeling and mapping mode. For instance, in the modeling mode, system 8 can generate a surface bounding the geometric model from the data points that are assigned to the model in block 310 (according to techniques that will be familiar to those of ordinary skill in the art) and output a graphical representation of the surface (e.g., on display 23). The model-splitting functionality described above in connection with FIGS. 4 and 5 can also be applied in the modeling mode.

In the mapping mode, system 8 can generate an electrophysiology map (e.g., a map of local activation times, local conduction velocities, cycle lengths, and so on) from the data points that are assigned to the map in block 310. Insofar as the data points are not pre-assigned to a model in the mapping mode (because the mapping mode bypasses block 304), however, system 8 must assign the data points to a model prior to outputting a graphical representation of the electrophysiology map. Various suitable techniques for assigning map data to geometric models are known and include, without limitation, group-specific projection and closest surface projection.

Although several embodiments have been described above with a certain degree of particularity, those skilled in the art could make numerous alterations to the disclosed embodiments without departing from the spirit or scope of this invention.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of conducting an electrophysiology study, comprising:
receiving, at an electroanatomical mapping system, a first user input specifying a geometric model to be generated;
receiving, at the electroanatomical mapping system, a second user input specifying an electrophysiology map to be generated;
after receiving the first user input and the second user input, receiving, at the electroanatomical mapping system, a plurality of data points from a multi-electrode catheter, wherein each data point of the plurality of data points includes location data; and
the electroanatomical mapping system assigning each data point of the plurality of data points to the geometric model and the electrophysiology map.

2. The method according to claim 1, further comprising the electroanatomical mapping system:
generating a surface bounding the geometric model from the plurality of data points assigned to the geometric model;
outputting a graphical representation of the surface; and
outputting a graphical representation of the electrophysiology map on the graphical representation of the surface according to the location data of the plurality of data points assigned to the electrophysiology map.

3. The method according to claim 2, wherein a respective data point is only output as part of the graphical representation of the electrophysiology map when the location data of the respective data point places the respective data point within a preset projection distance threshold of the surface.

4. The method according to claim 1, further comprising:
receiving, at the electroanatomical mapping system, a third user input splitting the geometric model into a first geometric model and a second geometric model;
the electroanatomical mapping system reassigning a first subset of the plurality of data points from the geometric model to the first geometric model; and
the electroanatomical mapping system reassigning a second subset of the plurality of data points from the geometric model to the second geometric model.

5. The method according to claim 4, wherein the third user input comprises a bounding box drawn on a graphical representation of a surface bounding the geometric model, wherein the bounding box defines the first geometric model and the second geometric model is defined by removing the first geometric model from the geometric model.

6. The method according to claim 5, wherein the electroanatomical mapping system includes a respective data point within the first subset of the plurality of data points when the location data of the respective data point places the respective data point within the bounding box, and wherein the electroanatomical mapping system otherwise includes the respective data point within the second subset of the plurality of data points.

7. A method of conducting an electrophysiology study, comprising:
receiving, at an electroanatomical mapping system, a first user input specifying one of a modeling mode, a mapping mode, or a combined modeling and mapping mode;
when the user input specifies the modeling mode, receiving, at the electroanatomical mapping system, a second user input specifying a geometric model to be generated;
when the user input specifies the mapping mode, receiving, at the electroanatomical mapping system, a third user input specifying an electrophysiology map to be generated;
when the user input specifies the combined modeling and mapping mode, receiving, at the electroanatomical mapping system, a fourth user input specifying both the geometric model to be generated and the electrophysiology map to be generated;
after receiving the first user input and either the second user input, the third user input, or the fourth user input, receiving, at the electroanatomical mapping system, a plurality of data points from a multi-electrode catheter, wherein each data point of the plurality of data points includes location data;
when the user input specifies the modeling mode, the electroanatomical mapping system assigning each data point of the plurality of data points only to the geometric model;
when the user input specifies the mapping mode, the electroanatomical mapping system assigning each data point of the plurality of data points only to the electrophysiology map; and
when the user input specifies the combined modeling and mapping mode, the electroanatomical mapping system assigning each data point of the plurality of data points to both the geometric model and the electrophysiology map.

8. The method according to claim 7, further comprising, when the user input specifies the modeling mode, the electroanatomical mapping system:
generating a surface bounding the geometric model from the plurality of data points assigned only to the geometric model; and
outputting a graphical representation of the surface.

9. The method according to claim 8, further comprising the electroanatomical mapping system outputting a graphical representation of the electrophysiology map on the graphical representation of the surface according to one of:
a group-specific projection of the plurality of data points to the graphical representation of the surface; and
a closest surface projection of the plurality of data points to the graphical representation of the surface.

10. The method according to claim 7, further comprising, when the user input specifies the mapping mode, the electroanatomical mapping system assigning each data point of the plurality of data points to the geometric model according to one of:
a group-specific projection of the plurality of data points to the geometric model; and
a closest surface projection of the plurality of data points to the geometric model.

11. The method according to claim 7, further comprising, when the user input specifies the combined modeling and mapping mode, the electroanatomical mapping system:
generating a surface bounding the geometric model from the plurality of data points assigned to the geometric model;
outputting a graphical representation of the surface; and
outputting a graphical representation of the electrophysiology map on the graphical representation of the surface according to the location data of the plurality of data points assigned to the electrophysiology map.

12. The method according to claim 11, wherein a respective data point is only output as part of the graphical representation of the electrophysiology map when the location data of the respective data point places the respective data point within a preset projection distance threshold of the surface.

13. The method according to claim 11, further comprising:
receiving, at the electroanatomical mapping system, a fifth user input splitting the geometric model into a first geometric model and a second geometric model;
the electroanatomical mapping system reassigning a first subset of the plurality of data points from the geometric model to the first geometric model; and
the electroanatomical mapping system reassigning a second subset of the plurality of data points from the geometric model to the second geometric model.

14. The method according to claim 13, wherein the fifth user input comprises a bounding box drawn on the graphical representation of the surface, wherein the bounding box defines the first geometric model and the second geometric model is defined by removing the first geometric model from the geometric model.

15. The method according to claim 14, wherein the electroanatomical mapping system includes a respective data point within the first subset of the plurality of data points when the location data of the respective data point places the respective data point within the bounding box, and wherein the electroanatomical mapping system otherwise includes the respective data point within the second subset of the plurality of data points.
